(19) United States
(12) Patent Application Publication
(10) Pub. No.: US 2021/0155424 A1
(43) Pub. Date: May 27, 2021

(54) ASPHALT RECEIVING VEHICLE WITH GUIDANCE LIGHTS FOR SUPPLY TRUCKS

(71) Applicant: Roadtec, Inc., Chattanooga, TN (US)

(72) Inventors: John E. Hoffmann, Signal Mountain, TN (US); Nathan Beckman, Chattanooga, TN (US); Matthew Neisen, Soddy Daisy, TN (US)

(73) Assignee: Roadtec, Inc., Chattanooga, TN (US)

(21) Appl. No.: 17/103,370

(22) Filed: Nov. 24, 2020

Related U.S. Application Data
(60) Provisional application No. 62/941,088, filed on Nov. 27, 2019.

(51) Int. Cl. B65G 67/24; E01C 23/00; B60Q 1/28; B65G 47/18

(52) U.S. Cl. CPC B65G 67/24; E01C 23/00; E01C 2301/04; B65G 47/18; B60Q 1/28

(57) ABSTRACT

An asphalt receiving vehicle includes a receiving hopper that is adapted to receive a load of asphalt paving material from a supply truck, and a conveyor that is adapted to convey the asphalt paving material received from the supply truck out of the receiving hopper. A plurality of guidance lights are mounted on the asphalt receiving vehicle so as to illuminate the roadway adjacent to the receiving hopper to provide a landing pattern to assist a driver of the supply truck to properly maneuver the supply truck as the supply truck is backed into position adjacent the receiving hopper. In a preferred embodiment of the invention, the plurality of guidance lights may also be used individually as directional signals.

### CROSS-REFERENCE TO RELATED APPLICATION

This application claims the benefit of U.S. Provisional Patent Application No. 62/941,088, which was filed on Nov. 27, 2019.

### FIELD OF THE INVENTION

This invention relates generally to asphalt receiving vehicles that are adapted to receive asphalt paving materials directly from a supply truck. Such vehicles include asphalt paving machines and material transfer vehicles that are used in transporting asphalt paving material from a supply truck to an asphalt paving machine. More particularly, the invention relates to an asphalt receiving vehicle that is equipped with guidance lights to help the operator of a supply truck locate the truck in the proper position for unloading its load of asphalt paving material into a receiving hopper of the asphalt receiving vehicle.

### BACKGROUND OF THE INVENTION

Asphalt paving material is comprised of an asphaltic binder and aggregates of various particle sizes, including both coarse and fine aggregate materials. Because the equipment needed to produce asphalt paving material is expensive and the space required extensive, asphalt paving material is typically produced in a production facility that is dedicated to such purpose. Consequently, it is frequently necessary to transport the asphalt paving material from its place of origin to an asphalt paving machine at a remote paving site. The asphalt paving material is usually transported in dump-type supply trucks to an asphalt paving machine or to a material transfer vehicle that completes the transfer to the asphalt paving machine.

An asphalt paving machine is a type of asphalt receiving vehicle comprising a self-propelled vehicle that is driven by a wheeled or tracked drive system. The asphalt paving machine includes a receiving hopper for receiving asphalt paving material and a conveyor that is associated with the receiving hopper. In a common type of paving machine, the receiving hopper is located at the front end of the machine to receive asphalt paving material, and a slat-type hopper conveyor that is located below the receiving hopper transfers the asphalt paving material from the hopper to a distribution assembly comprising a transverse distributing auger that is mounted at the rear of the machine. The asphalt paving material is deposited onto and across the roadway or other surface to be paved by the distributing auger, and a floating screed located behind the distributing auger compacts the asphalt paving material to form an asphalt mat.

When asphalt paving material is discharged directly from a supply truck into the receiving hopper of the asphalt paving machine, the dump-type supply truck is unloaded by backing the truck into position adjacent the front end of the receiving hopper so that the rear wheels of the supply truck abut rollers on the front end of the receiving hopper. Then, when the truck bed is raised, the asphalt paving material will slide down the bed into the receiving hopper. When the truck bed is raised, it should not come into contact with the receiving hopper and should not be carried by or ride on any portion of the paving machine. For smaller-capacity supply trucks, contact between the truck bed and the asphalt paving machine is not often a problem. However, such contact can be a problem when large tractor-semitrailer units are used as delivery vehicles, particularly when the truck bed is extended to its highest point. In addition, if a supply truck contacts the paving machine so that a portion of the weight of the truck is carried by the paving machine as the paving operation is carried out, the screed elevation may be changed, which will affect the elevation and smoothness of the finished asphalt mat.

When asphalt paving material is being delivered to the paving machine by supply trucks, it is frequently necessary for a series of trucks to move into contact with the front end of the paving machine to serially discharge their loads into the paving machine's receiving hopper. This method of delivery requires multiple truck maneuvers that are often difficult to achieve without stopping the paving machine. However, when a paving machine stops and subsequently restarts, its floating screed will produce a dip in the asphalt mat (when the machine stops) and a bump (when it restarts). In addition, because a typical supply truck carries more asphalt paving material than can be unloaded quickly into the receiving hopper of the asphalt paving machine, it is frequently necessary for the paving machine to push the truck in the paving direction as the truck is unloaded while paving proceeds. This may be difficult to manage when the paving machine is proceeding through intersections or operating on curved sections of the roadway.

The ability of the paving machine operator to place a smooth asphalt mat on the roadway will also be affected by the rate of feed of asphalt paving material to the paving machine. This requires planning for proper scheduling of supply trucks and coordination with the asphalt production facility. However delays at the production facility or traffic encountered by the supply trucks can thwart the efforts of the most careful planners. Consequently, because it is desirable to keep the paving machine moving at all times during an asphalt paving operation, and since supply trucks must be unloaded as they are pushed along in the paving direction, it is frequently necessary to have supply trucks queue up near the paving machine to ensure that a loaded truck is available to move quickly into unloading position as an unloaded truck is moved out of the way. This may result in heat losses in the asphalt paving material in the waiting trucks, which can affect the quality of the asphalt mat being created by the paving machine.

For all of the difficulties associated with the timely delivery of asphalt paving material by individual supply trucks into the receiving hopper of a paving machine, material transfer vehicles have been used in recent years to transport asphalt paving material to an asphalt paving machine. A material transfer vehicle is a type of asphalt receiving vehicle that may be used to shuttle asphalt paving material between the supply trucks and the asphalt paving machine. A material transfer vehicle, like an asphalt paving machine, includes a receiving hopper and a conveyor that is associated with the receiving hopper. A typical material transfer vehicle is equipped with a receiving hopper into which a supply truck may dump its entire load. In order to do so, the supply truck will back into contact with the front end of the receiving hopper and raise its dump bed so that the asphalt paving material will slide into the receiving hopper. In this regard, the unloading operation into the receiving hopper of a material transfer vehicle is substantially similar to the unloading operation into the receiving hopper of an asphalt paving machine.

A material transfer vehicle is adapted to move alongside an asphalt paving machine and transfer the asphalt paving material received from a supply truck into the receiving hopper of the asphalt paving machine. Still another type of material transfer vehicle is adapted to move alongside the asphalt paving machine while being tethered to a supply truck to allow for the transfer of asphalt paving material from a supply truck to an asphalt paving machine without requiring either the supply truck or the material transfer vehicle to make direct contact with the asphalt paving machine, thus reducing the time required for supply truck maneuvers and reducing the risk that the paving machine will have to stop during the paving operation.

Self-propelled material transfer vehicles may include a large-capacity receiving hopper and an inclined loading conveyor extending upwardly from the receiving hopper. A transversely oriented auger in the receiving hopper may be provided to urge asphalt paving material onto the loading conveyor. The asphalt paving material is carried upwardly by the loading conveyor from the receiving hopper and discharged off the elevated output end of the loading conveyor into a chute mounted on the lower end of a discharge conveyor, or into an intermediate surge bin that is sized to hold the entire load of a supply truck. The discharge of asphalt paving material off the elevated output end of the loading conveyor so that it may fall under the influence of gravity into a chute or surge bin assists in preventing undesirable segregation of the various particulate components of the asphalt paving material by particle size.

Material transfer vehicles of the type that are equipped with a surge bin typically include an auger in the surge bin that re-blends the asphalt paving material to eliminate particle size segregation that occurs as the asphalt paving material is transported. It also helps to keep the heat in the asphalt paving material evenly distributed throughout the entire load of material obtained from the supply truck. In addition, these material transfer vehicles include a conveyor in the surge bin that is adapted to transfer the asphalt paving material to the discharge conveyor.

Discharge conveyors that are mounted on self-propelled material transfer vehicles with and without surge bins are generally pivotable about a substantially vertical axis so that the material transfer vehicle can be positioned adjacent to an asphalt paving machine that is laying an asphalt mat and rapidly discharge asphalt paving material into the receiving hopper of the paving machine as the material transfer vehicle moves with the paving machine along the roadway. Furthermore, these discharge conveyors are configured so that their discharge end may be raised and lowered to position the discharge outlet advantageously with respect to the receiving hopper of a paving machine. The moveable nature of these discharge conveyors allows for some flexibility in locating the material transfer vehicle adjacent to the asphalt paving machine. Because of its rapid loading and unloading capabilities, a self-propelled material transfer vehicle equipped with a surge bin can rapidly shuttle between supply trucks at a pick-up point and an asphalt paving machine that is laying an asphalt mat at a paving site so that there is less likelihood that the paving machine will have to stop paving because of a lack of asphalt paving material.

When a self-propelled material transfer vehicle with a surge bin is used in an asphalt paving process, a supply truck can be stopped a significant distance away from the paving machine in order to unload its load of asphalt paving material from a stopped position into the material transfer vehicle. Thus, the supply truck can unload faster when not unloading directly into the moving paving machine, and the unloading location may be selected so that there is no danger of the raised dump bed of the truck hitting power lines or tree limbs on the side of the roadway. The use of a material transfer vehicle also reduces the need for supply trucks to queue up at the paving machine in order to keep it moving, thereby cutting the waiting time of the supply trucks and thereby reducing truck operating costs.

It is common for paving to take place at night in order to minimize the inconvenience to highway travelers. It is also common that a convenient location for the transfer of asphalt paving material from a supply truck to an asphalt paving machine or to a material transfer vehicle may not be well lighted. Furthermore, the lights on the rear end of a supply truck are provided to give notice to those in its vicinity that the supply truck is backing up or braking. No lights are provided on a conventional supply truck to light its path to guide the driver when traveling in reverse. Consequently, it is difficult for the driver of a supply truck to clearly see a path to the receiving hopper of an asphalt paving machine or a material transfer vehicle for unloading asphalt paving material in the dark. Furthermore, although an asphalt paving machine or a material transfer vehicle may be equipped with running lights to allow the operator to steer the vehicle on a roadway, conventional paving machines and material transfer vehicles do not include any lighting that is directed onto the roadway and is specifically adapted for guiding a supply truck into the proper position for unloading its load of asphalt paving material into the receiving hopper of the asphalt receiving vehicle. It would be desirable if such guidance lighting for supply trucks could be provided.

### Advantages of the Invention

Among the advantages of the invention is that it provides an asphalt receiving vehicle that is equipped with guidance lights that are directed onto the roadway and adapted to assist the driver of a supply truck in maneuvering the truck to the proper position with respect to the receiving hopper of the asphalt paving machine or material transfer vehicle for easy and efficient unloading. Other advantages and features of this invention will become apparent from an examination of the drawings and the ensuing description.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The term “substantially” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships, unless otherwise specified herein or clearly indicated as having a different relationship by context. The terms “operatively attached” and “operatively connected” describe such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

Several terms are specifically defined herein. These terms are to be given their broadest reasonable construction consistent with such definitions, as follows:

The term “asphalt paving material” refers to a bituminous paving mixture that is comprised of asphalt cement and crushed stone, recycled asphalt shingles, recycled asphalt pavement materials and/or other aggregate materials of varying particle size, and which is used for paving purposes.

The term “asphalt receiving vehicle” refers to a self-propelled vehicle that includes a receiving hopper for receiving asphalt paving material from a supply truck, and a conveyor that is associated with the receiving hopper. Asphalt receiving vehicles include asphalt paving machines and material transfer vehicles.

The terms “asphalt paving machine” and “paving machine” refer to a finishing machine for applying asphalt paving material to form an asphalt mat on a roadway (which may include a parking lot or similar surface). An asphalt paving machine or paving machine is typically a self-propelled vehicle having a receiving hopper on its front end, a distributing auger for distributing asphalt paving material across a roadway, a conveyor for moving the asphalt paving material from the receiving hopper to the distributing auger, and a floating screed located behind the distributing auger for forming an asphalt mat on the roadway.

The term “asphalt mat” refers to a layer of asphalt paving material such as is applied by an asphalt paving machine to produce or resurface a roadway.

The term “material transfer vehicle” refers to a self-propelled vehicle having a receiving hopper that is adapted to receive asphalt paving material from a supply truck, a conveyor that is associated with the receiving hopper, and a discharge conveyor that is adapted to convey the asphalt paving material received from the supply truck to the receiving hopper of an asphalt paving machine.

The term “top”, as used herein to describe a direction or relative position on or with respect to an asphalt receiving vehicle, or a component or portion of such a vehicle, refers to a direction or relative position that is farther away from the roadway surface on which the asphalt receiving vehicle is placed for operation.

The term “left”, as used herein to describe a direction or relative position of an asphalt receiving vehicle or an assembly, component or portion of such a vehicle, refers to a direction or position towards the left, from the perspective of the operator who is operating the vehicle with the receiving hopper in the leading direction.

The term “right”, as used herein to describe a direction or relative position of an asphalt receiving vehicle or an assembly, component or portion of such a vehicle, refers to a direction or position towards the right, from the perspective of the operator who is operating the vehicle with the receiving hopper in the leading direction.

### SUMMARY OF THE INVENTION

The invention comprises an asphalt receiving vehicle that includes a receiving hopper that is adapted to receive a load of asphalt paving material from a supply truck, and a conveyor that is associated with the receiving hopper. A plurality of guidance lights are mounted on the asphalt receiving vehicle so as to illuminate the roadway adjacent to the receiving hopper to provide a landing pattern to assist a driver of the supply truck to properly maneuver the supply truck as the supply truck is backed into position adjacent the receiving hopper.

In a preferred embodiment of the invention, the plurality of guidance lights may also be used individually as directional signals to allow the operator of the asphalt receiving vehicle to signal to others in and around the roadway when the vehicle is about to make a turn.

In order to facilitate an understanding of the invention, the preferred embodiments of the invention, as well as the best mode known by the inventor for carrying out the invention, is illustrated in the drawings, and a detailed description thereof follows. It is not intended, however, that the invention be limited to the particular embodiments described or to use in connection with the apparatus illustrated herein. Therefore, the scope of the invention contemplated by the inventor includes all equivalents of the subject matter described and claimed herein, as well as various modifications and alternative embodiments such as would ordinarily occur to one skilled in the art to which the invention relates. The inventor expects skilled artisans to employ such variations as seem to them appropriate, including the practice of the invention otherwise than as specifically described herein. In addition, any combination of the elements and components of the invention described herein in any possible variation is encompassed by the invention, unless otherwise indicated herein or clearly excluded by context.

### BRIEF DESCRIPTION OF THE DRAWINGS

The presently preferred embodiment of the invention is illustrated in the accompanying drawings, in which like reference numerals represent like parts throughout, and wherein:

FIG. 1 is a side view of a first embodiment of a conventional material transfer vehicle of a type that may be configured with a supply truck guidance lighting system according to the invention.

FIG. 2 is a perspective view of a second embodiment of a conventional material transfer vehicle of a type that may be configured with a supply truck guidance lighting system according to the invention.

FIG. 3 is an end view of the receiving hopper of a material transfer vehicle similar to that shown in FIG. 1 that has been configured with a supply truck guidance lighting system according to the invention.

FIG. 4 is a top view of the receiving hopper shown in FIG. 3, illustrating the light pattern produced by a preferred embodiment of the invention.

FIG. 5 is a perspective view of the receiving hopper shown in FIGS. 3 and 4.

FIG. 6 is a side view of the receiving hopper shown in FIGS. 3 through 5.

FIG. 7 is a front view of a control panel comprising a controller for operating the material transfer vehicle that has been configured with a supply truck guidance lighting system according to the invention.

FIG. 8 is a side view of an asphalt paving machine that has been configured with a supply truck guidance lighting system according to the invention.

FIG. 9 is an end view of the asphalt paving machine shown in FIG. 8.

FIG. 10 is a top view of the asphalt paving machine shown in FIGS. 8 and 9, illustrating the light pattern produced by a preferred embodiment of the invention.

### DESCRIPTION OF THE PREFERRED EMBODIMENTS OF THE INVENTION

This description of the preferred embodiments of the invention is intended to be read in connection with the accompanying drawings, which are to be considered part of the entire written description of this invention. The drawing figures are not necessarily to scale, and certain features of the invention may be shown exaggerated in scale or in somewhat schematic form in the interest of clarity and conciseness.

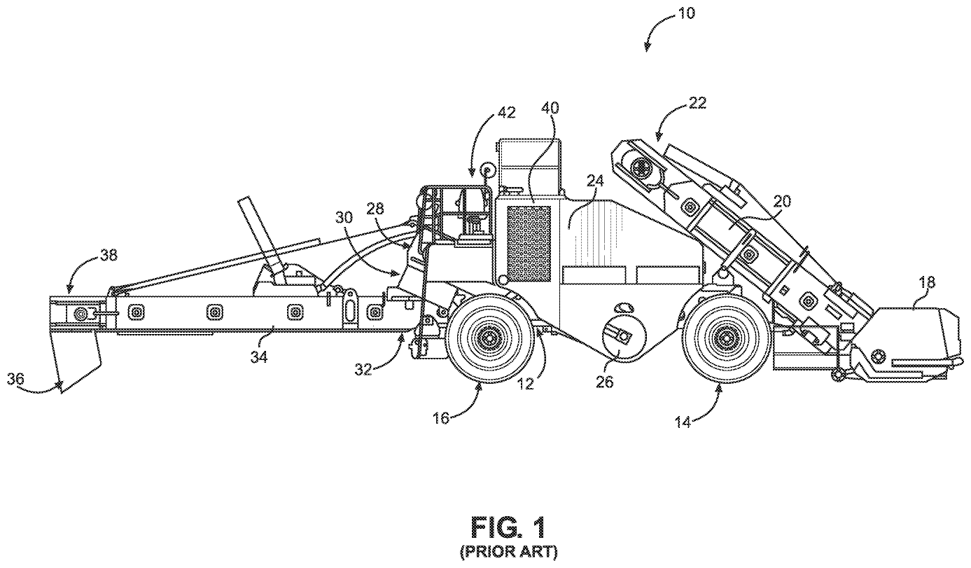

FIG. 1 illustrates a conventional self-propelled material transfer vehicle that may be configured with a supply truck guidance lighting system according to the invention. As shown therein, material transfer vehicle 10 includes a frame 12 that is supported on the roadway surface by front and rear ground-engaging drive assemblies including right front drive wheel 14 and right rear drive wheel 16. Material transfer vehicle 10 also includes a left front drive wheel (not shown but substantially similar to right front drive wheel 14) and a left rear drive wheel (not shown but substantially similar to right rear drive wheel 16). Each of the drive wheels is driven by a hydraulic motor (not shown) that is supplied with fluid under pressure by one or more hydraulic pumps (also not shown). In the alternative, the frame of the vehicle may be supported on the roadway surface by ground-engaging drive assemblies comprising one or more left side track-drive assemblies (not shown), and one or more right side track-drive assemblies (also not shown), as is known to those having ordinary skill in the art to which the invention relates.

Vehicle 10 includes receiving hopper 18, which is adapted to receive asphalt paving material from a supply truck (not shown). An auger (not shown) is mounted in receiving hopper 18 and is adapted to assist in conveying asphalt paving material from receiving hopper 18 into loading conveyor 20, which in turn conveys the asphalt paving material off of its output end 22 and into surge bin 24. The surge bin includes transverse auger 26 that is employed to mix the asphalt paving material in the surge bin in order to minimize segregation or separation of the aggregate portion of the asphalt paving material by size. Also located in the surge bin is surge conveyor 28, which is adapted to convey asphalt paving material upwardly out of the surge bin so that it may fall through chute 30 and onto input end 32 of discharge conveyor 34. Discharge conveyor 34 is mounted for vertical pivotal movement about a substantially horizontal pivot axis at its input end that is perpendicular to the page of FIG. 1, as raised and lowered by a linear actuator (not shown). Discharge conveyor 34 is also adapted for side-to-side movement about a substantially vertical axis by operation of one or more additional actuators (also not shown). Asphalt paving material that falls through chute 30 onto discharge conveyor 34 is discharged through chute 36 at conveyor output end 38 into a receiving hopper of an asphalt paving machine (not shown in FIG. 1).

Hydraulic drive systems including hydraulic pumps and hydraulic motors are provided to drive the various augers and conveyors of material transfer vehicle 10. An engine (not shown) is located within engine compartment 40 adjacent to operator's station 42 and provides the motive force for the hydraulic pumps that drive the hydraulic motors for the drive wheels, the augers and the various conveyors and other components of the vehicle.

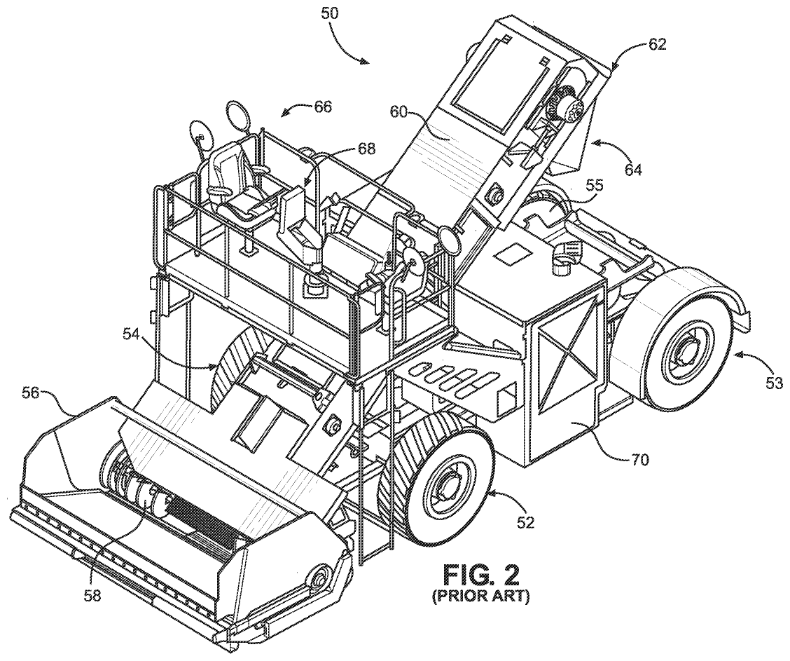

FIG. 2 illustrates an alternative conventional material transfer vehicle 50 that may be configured with a supply truck guidance lighting system according to the invention. As shown therein, material transfer vehicle 50 includes a frame that is supported on the roadway surface by front and rear ground-engaging drive assemblies comprising left front drive wheel 52 and left rear drive wheel 53. Material transfer vehicle 50 also includes right front drive wheel 54 and right rear drive wheel 55. Each of the drive wheels is driven by a hydraulic motor (not shown) that is supplied with fluid under pressure by one or more hydraulic pumps (also not shown). In the alternative, the frame of the vehicle may be supported on the roadway surface by ground-engaging drive assemblies comprising one or more left side track-drive assemblies (not shown), and one or more right side track-drive assemblies (also not shown).

Vehicle 50 includes receiving hopper 56, which is adapted to receive asphalt paving material from a supply truck (not shown). Receiving hopper 56 is essentially identical to receiving hopper 18 of material transfer vehicle 10. Auger 58 in receiving hopper 56 is adapted to urge asphalt paving material into loading conveyor 60. Loading conveyor 60 is operatively attached to the receiving hopper and is adapted to convey asphalt paving material from receiving hopper 56 upwardly to its output end 62, from which it will fall through chute 64 onto the lower input end of a discharge conveyor (not shown, but substantially similar to discharge conveyor 34). Material transfer vehicle 50 also includes operator's station 66 from which all operating functions of the vehicle may be controlled via a control panel comprising controller 68.

Material transfer vehicle 50 includes various hydraulic pumps and hydraulic motors, which are provided to drive the various augers and conveyors. An engine (not shown, but located in engine compartment 70) provides the motive force for the hydraulic pumps that drive the hydraulic motors for the drive wheels, the augers and conveyors and other components of the vehicle.

Controller 68 includes or is associated with a memory or data storage component. It may also include a data input component such as a touch screen, a joy stick, a keyboard and/or a plurality of actuating buttons for receiving input from an operator of the material transfer vehicle. Controller 68 may include a data output component such as a display screen, a secondary storage device, a processor and other components for running an application. Various circuits, including but not limited to power supply circuitry and hydraulic circuitry, may be associated with and operatively connected to the controller. Numerous commercially available microprocessors can be configured to perform the functions of controller 68. It should be appreciated that the controller could readily be embodied in a general purpose computer or machine microprocessor capable of controlling numerous functions of material transfer vehicle 50.

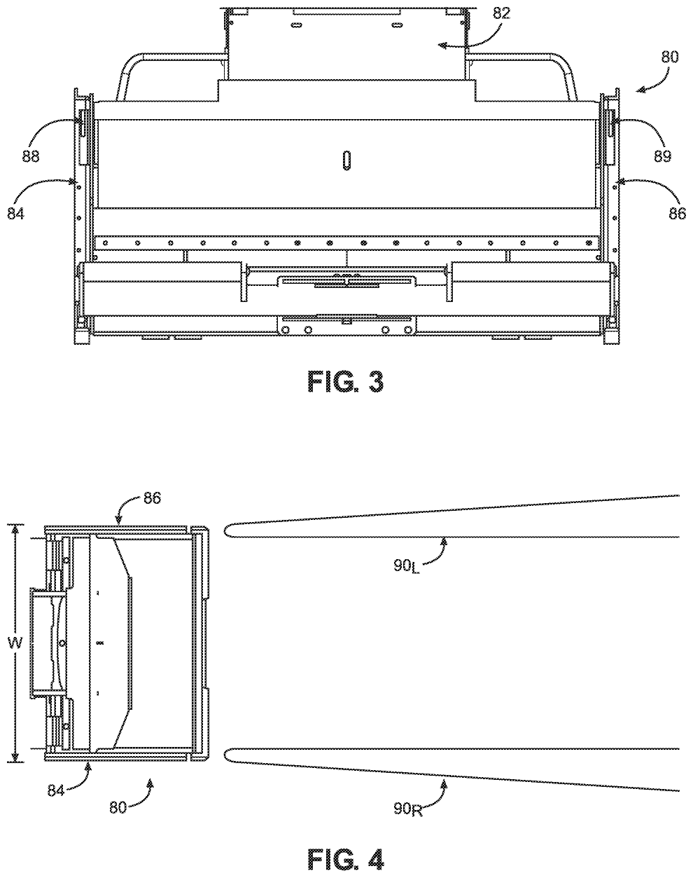

FIGS. 3 through 7 illustrate an embodiment of the invention as applied to a material transfer vehicle. As shown therein, receiving hopper 80 of a material transfer vehicle (otherwise not shown) is substantially similar to receiving hopper 18 of material transfer vehicle 10 and to receiving hopper 56 of material transfer vehicle 50. Receiving hopper 80 is adapted to receive asphalt paving material from a supply truck (not shown). An auger (not shown, but substantially similar to auger 58) is mounted in receiving hopper 80 and is adapted to assist in conveying asphalt paving material from receiving hopper 80 into loading conveyor 82. A plurality of guidance lights are mounted so as to illuminate the roadway adjacent to the receiving hopper to provide a landing pattern to assist a supply truck driver to properly maneuver a supply truck as the truck is backed into position adjacent receiving hopper 80, in order to permit easy and efficient discharge of asphalt paving material into receiving hopper 80.

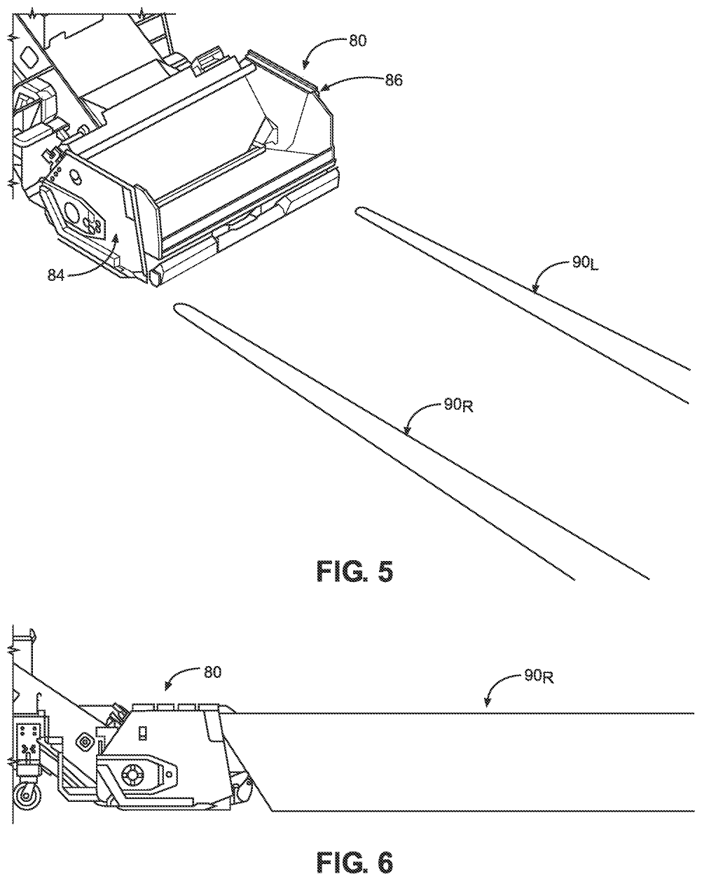

Preferably, the plurality of guidance lights are mounted on receiving hopper 80 and are directed so as to illuminate the roadway extending away from the receiving hopper to provide a landing pattern to assist a supply truck driver to properly maneuver a supply truck as the truck is backed into position adjacent receiving hopper 80, in order to permit easy and efficient discharge of asphalt paving material into receiving hopper 80. Thus, as shown in FIGS. 3 through 6, receiving hopper 80 comprises right sidewall 84 and left sidewall 86 that define the width “W” of the receiving hopper. In this embodiment of the invention, right guidance light 88 is mounted on right sidewall 84, and left guidance light 89 is mounted on left sidewall 86. These lights are preferably mounted at or near the top of sidewalls 84 and 86 and are directed so as to illuminate the roadway extending away from the receiving hopper to provide a landing pattern comprising left illumination guide 90_{L} that is projected on the roadway and right illumination guide 90_{R} that is projected on the roadway (as shown in FIGS. 4 and 5) to assist a supply truck driver to properly maneuver a supply truck as the truck is backed into position adjacent receiving hopper 80, in order to permit easy and efficient discharge of asphalt paving material into receiving hopper 80.

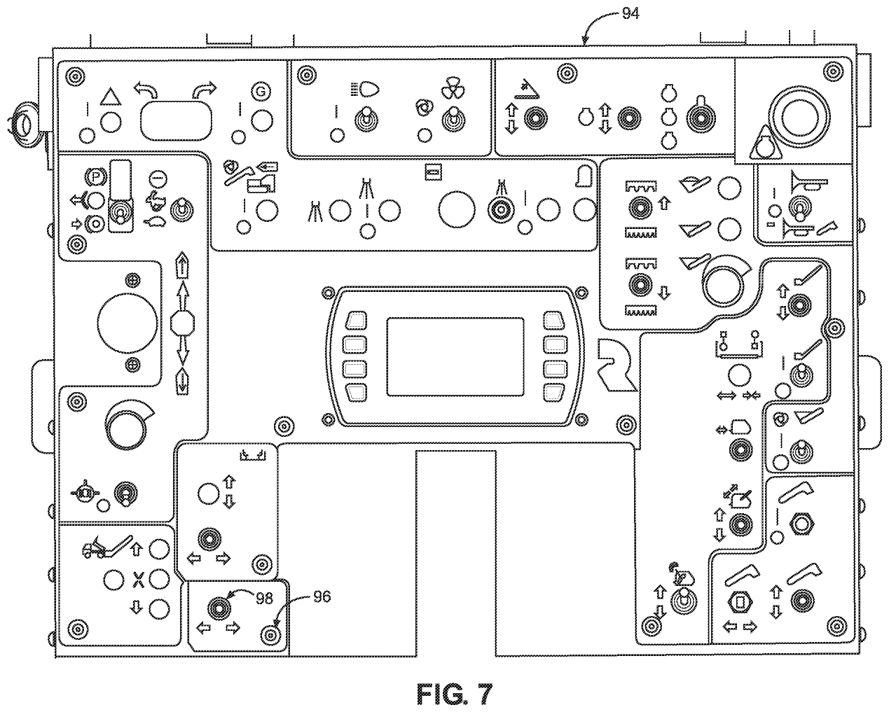

Control panel 94 (shown in FIG. 7) comprises a controller to which guidance lights 88 and 89 are operatively connected. This controller is substantially similar to controller 68 and is preferably adapted to control all of the operations of the material transfer vehicle, including the guidance lights. Control panel 94 includes activation switch 96 that is operatively connected to the controller and to guidance lights 88 and 89. Activation of switch 96 allows an operator of the material transfer vehicle to turn on the plurality of guidance lights at the same time.

In a preferred embodiment of the invention, guidance lights 88 and 89 may also be operated individually as directional signals that an operator of the material transfer vehicle may use to indicate when the material transfer vehicle is making a turn on the roadway. Thus, an operator may operate a directional switch, such as by pushing toggle switch 98 to the right to activate right guidance light 88 as a right turn directional signal, or the operator may operate a directional switch, such as by pushing toggle switch 98 to the left to activate guidance light 89 as a left turn directional signal. Preferably, in this embodiment of the invention, the controller will cause the activated directional signal to intermittently blink in the same manner as the directional signals on an automobile. In other embodiments of the invention, activation switch 96 and toggle switch 98 may be combined in a single switch device (not shown) as is known to those having ordinary skill in the art to which the invention relates.

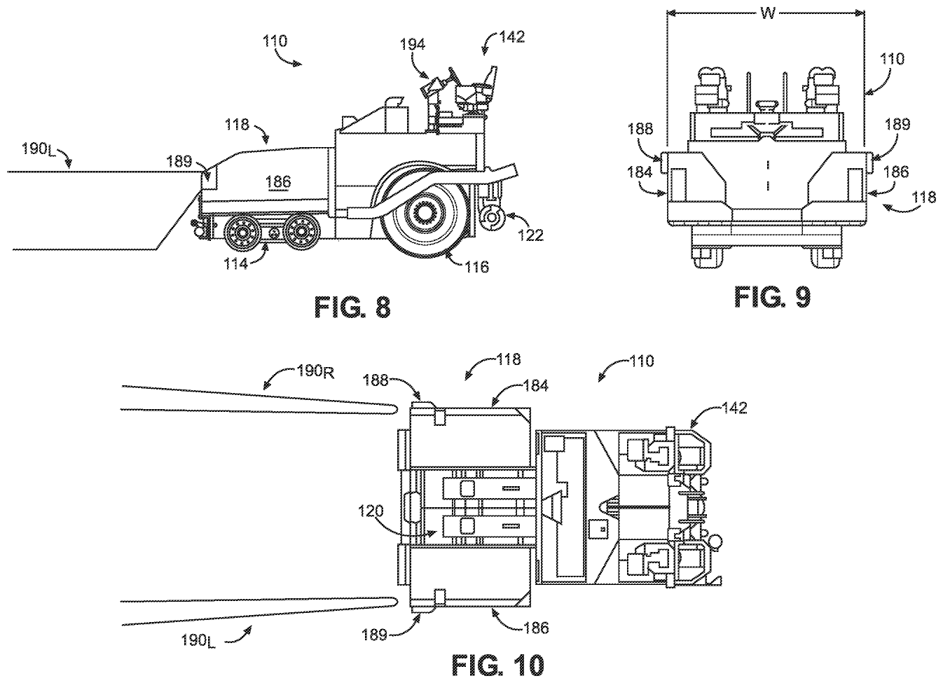

FIGS. 8 through 10 illustrate an embodiment of the invention as applied to an asphalt paving machine. As shown therein, asphalt paving machine 110 is a self-propelled vehicle that is driven by a wheeled drive system including left front wheel assembly 114 and left rear drive wheel 116. Asphalt paving machine 110 also includes a right front wheel assembly (not shown but substantially similar to left front wheel assembly 114) and a right rear drive wheel (not shown but substantially similar to left rear drive wheel 116). Each of the drive wheel assemblies is driven by a hydraulic motor (not shown) that is supplied with fluid under pressure by one or more hydraulic pumps (also not shown). In the alternative, the frame of the asphalt paving machine may be supported on the roadway surface by ground-engaging drive assemblies comprising one or more left side track-drive assemblies (not shown), and one or more right side track-drive assemblies (also not shown), as is known to those having ordinary skill in the art to which the invention relates. Receiving hopper 118 is located at the front end of the machine to receive asphalt paving material, and slat-type hopper conveyor 120 located below the receiving hopper transfers the asphalt paving material from the hopper to a distribution assembly comprising transverse distributing auger 122 that is mounted at the rear of the machine. The asphalt paving material is deposited onto and across the roadway or other surface to be paved by the distributing auger, and floating screed (not shown) located behind the distributing auger compacts the asphalt paving material to form an asphalt mat.

Asphalt paving machine 110 is operated by an operator in operator's station 142, from which all operating functions of the paving machine may be controlled via control panel 194 comprising a controller that is similar to the controller comprised by control panel 94 of the material transfer vehicle which is illustrated in part in FIGS. 3 through 7. A plurality of guidance lights are mounted so as to illuminate the roadway adjacent to the receiving hopper to provide a landing pattern to assist a supply truck driver to properly maneuver a supply truck as the truck is backed into position adjacent receiving hopper 118, in order to permit easy and efficient discharge of asphalt paving material into receiving hopper 118.

Preferably, the plurality of guidance lights are mounted on receiving hopper 118 and are directed so as to illuminate the roadway extending away from the receiving hopper to provide a landing pattern to assist a supply truck driver to properly maneuver a supply truck as the truck is backed into position adjacent receiving hopper 118, in order to permit easy and efficient discharge of asphalt paving material into receiving hopper 118. Thus, as shown in FIGS. 9 and 10, receiving hopper 118 comprises right sidewall 184 and left sidewall 186 that define the width “W” of the receiving hopper. In this embodiment of the invention, right guidance light 188 is mounted on right sidewall 184, and left guidance light 189 is mounted on left sidewall 186. These lights are preferably mounted at or near the top of sidewalls 184 and 186 and are directed so as to illuminate the roadway extending away from the receiving hopper to provide a landing pattern comprising left illumination guide 190_{L} that is projected on the roadway and right illumination guide 190_{R} that is projected on the roadway (as best shown in FIG. 10) to assist a supply truck driver to properly maneuver a supply truck as the truck is backed into position adjacent receiving hopper 118, in order to permit easy and efficient discharge of asphalt paving material into receiving hopper 118.

Control panel 194 comprises a controller to which guidance lights 188 and 189 are operatively connected. This controller is preferably adapted to control all of the operations of the asphalt paving machine, including the guidance lights. Thus, the control panel includes an activation switch (not shown but substantially similar to activation switch 96) that is operatively connected to the controller and to guidance lights 188 and 189. Activation of this switch allows an operator of the asphalt paving machine to turn on the plurality of guidance lights at the same time.

In a preferred embodiment of the invention, guidance lights 188 and 189 may also be operated individually as directional signals that an operator of the asphalt paving machine may use to indicate when the asphalt paving machine is making a turn on the roadway. Thus, an operator may operate a directional switch, such as by pushing a toggle switch (not shown, but substantially similar to toggle switch 98) to the right to activate right guidance light 188 as a right turn directional signal, or the operator may operate a directional switch, such as by pushing the toggle switch to the left to activate guidance light 189 as a left turn directional signal. Preferably, in this embodiment of the invention, the controller will cause the activated directional signal to intermittently blink in the same manner as the directional signals on an automobile. In other embodiments of the invention, the activation switch and the toggle switch may be combined in a single switch device (not shown) as is known to those having ordinary skill in the art to which the invention relates.

The invention thus provides an asphalt receiving vehicle which is equipped with guidance lights for guiding the driver of a supply truck into a suitable unloading position adjacent the receiving hopper of the asphalt receiving vehicle.

Although this description contains many specifics, these should not be construed as limiting the scope of the invention but as merely providing illustrations of the presently preferred embodiment thereof, as well as the best mode contemplated by the inventor of carrying out the invention. The invention, as described herein, is susceptible to various modifications and adaptations, as would be understood by those having ordinary skill in the art to which the invention relates.

What is claimed is:

1. An asphalt receiving vehicle comprising:
(a) a receiving hopper that is adapted to receive a load of asphalt paving material from a supply truck;
(b) a conveyor that is associated with the receiving hopper and is adapted to convey the asphalt paving material received from the supply truck out of the receiving hopper;
(c) a plurality of guidance lights that are mounted so as to illuminate the roadway adjacent to the receiving hopper to provide a landing pattern to assist a driver of the supply truck to properly maneuver the supply truck as the supply truck is backed into position adjacent the receiving hopper.

2. The asphalt receiving vehicle of claim 1 wherein the plurality of guidance lights are mounted on the receiving hopper and are directed so as to illuminate the roadway extending away from the receiving hopper to provide a landing pattern to assist a supply truck driver to properly maneuver a supply truck as the truck is backed into position adjacent the receiving hopper.

3. The asphalt receiving vehicle of claim 2, wherein:
(a) the receiving hopper comprises a right sidewall and a left sidewall that define the width of the receiving hopper;
(b) the plurality of guidance lights comprises a right guidance light that is mounted on the right sidewall, and a left guidance light that is mounted on the left sidewall.

4. The asphalt receiving vehicle of claim 3 wherein:
(a) the right sidewall has a top;
(b) the right guidance light is mounted at or near the top of the right sidewall;
(c) the left sidewall has a top;
(d) the left guidance light is mounted at or near the top of the left sidewall.

5. The asphalt receiving vehicle of claim 4 wherein:
(a) the right guidance light is directed so as to illuminate the roadway extending away from the receiving hopper to provide a landing pattern comprising a right illumination guide that is projected on the roadway;
(b) the left guidance light is directed so as to illuminate the roadway extending away from the receiving hopper to provide a landing pattern comprising a left illumination guide that is projected on the roadway.

6. The asphalt receiving vehicle of claim 1 which includes a controller to which the plurality of guidance lights are operatively connected.

7. The asphalt receiving vehicle of claim 6 in which the controller comprises a control panel that includes an activation switch that is operatively connected to the controller and to the plurality of guidance lights, said activation switch being adapted to allow an operator of the asphalt receiving vehicle to turn on the plurality of guidance lights at the same time.

8. The asphalt receiving vehicle of claim 7 wherein the control panel includes a directional switch that allows an operator of the asphalt receiving vehicle to operate each of the plurality of guidance lights individually as directional signals to indicate when the asphalt receiving vehicle is making a turn on the roadway.

9. The asphalt receiving vehicle of claim 1:
(a) wherein the plurality of guidance lights includes:
(i) a right guidance light that is directed so as to illuminate the roadway extending away from the receiving hopper to provide a landing pattern comprising a right illumination guide that is projected on the roadway;
(ii) a left guidance light that is directed so as to illuminate the roadway extending away from the receiving hopper to provide a landing pattern comprising a left illumination guide that is projected on the roadway;
(b) which includes a controller to which the right guidance light and the left guidance light are operatively connected;
(c) which includes an activation switch that is operatively connected to the controller and to the right guidance light and the left guidance light, said activation switch being adapted to allow an operator of the asphalt receiving vehicle to turn on the right guidance light and the left guidance light at the same time;
(d) which includes a directional switch that allows an operator of the asphalt receiving vehicle to operate the right guidance light and the left guidance light individually as directional signals to indicate when the asphalt receiving vehicle is making a turn on the roadway.

10. The asphalt receiving vehicle of claim 9 wherein the controller is adapted to cause the activated directional signal, either the right guidance light or the left guidance light, to intermittently blink.

11. The asphalt receiving vehicle of claim 9 wherein the activation switch and the directional switch are combined in a single switch device.
